(19) United States
(12) Patent Application Publication
(10) Pub. No.: US 2019/0085148 A1
(43) Pub. Date: Mar. 21, 2019

(54) THERMALLY CONDUCTIVE SILICONE ELASTOMERS

(71) Applicant: GSDI Specialty Dispersions, Inc., Massillon, OH (US)

(72) Inventor: Raman RABINDRANATH, Cologne (DE)

(21) Appl. No.: 16/080,636

(22) PCT Filed: Feb. 24, 2017
(86) PCT No.: PCT/US17/19368

§ 371 Date: Aug. 28, 2018

Related U.S. Application Data
(60) Provisional application No. 62/301,009, filed on Feb. 29, 2016.

(51) Int. Cl. C08K 3/38; C08K 3/18; C08K 3/36

(52) U.S. Cl. CPC C08K 3/38; C08K 3/18; C08K 2003/2265; C08K 2003/385; C08K 3/36

(57) ABSTRACT

A mixture of silicone elastomer and carbonyl iron powder is disclosed, with the silicone elastomer being able to bind the iron powder in weight percents between 75 and 90 while surprising retaining an elastomeric hardness of between about 40 and 70 on the Shore A scale. The isotropic iron powder provides thermal conductivity and magnetism to the silicone elastomer which can be formed during crosslinking into any final shape desired.

### CLAIM OF PRIORITY

This application claims priority from U.S. Provisional Patent Application Ser. No. 62/301,009 bearing Attorney Docket Number 12016017 and filed on Feb. 29, 2016, which is incorporated by reference.

### FIELD OF THE INVENTION

This invention relates to silicone elastomer mixtures to which carbonyl iron particles are added and to methods of making those mixtures.

### BACKGROUND OF THE INVENTION

Polymer has taken the place of other materials in a variety of industries. Polymer has replaced glass to minimize breakage, reduce weight, and reduce energy consumed in manufacturing and transport. In other industries, polymer has replaced metal to minimize corrosion, reduce weight, and provide color-in-bulk products.

A variety of additives, functional and decorative, can be added to thermoplastic or thermoset polymer compositions by the addition of a masterbatch prior to final shaping of the polymer compounds into polymer articles. Typically, the masterbatch is added to polymer base resin and optionally other ingredients at the entry point for an extrusion or molding machine. Thorough melt-mixing of the masterbatch with and into the resin allows for consistent dispersion of the concentrated additives in the masterbatch into polymer resin for consistent performance properties of the polymer compound in the final polymer article.

Among of the functional or decorative additives are thermally conductive particulate.

### SUMMARY OF THE INVENTION

What the art needs is a silicone elastomer compound containing functional additive(s), preferably providing thermally conductive additives.

The present invention has found that, unexpectedly, the use of carbonyl iron particles in silicone elastomer can provide excellent through plane thermal conductivity.

One aspect of the invention is a silicone elastomer mixture, comprising: (a) silicone elastomer and (b) from about 60 to about 90 weight percent of carbonyl iron particles dispersed in the silicone elastomer, wherein the silicone elastomer mixture, when crosslinked with a silicone crosslinking agent, has a through-plane thermal conductivity between about 0.8 and about 2.5 W/mK.

Features will become apparent from a description of the embodiments of the invention.

### EMBODIMENTS OF THE INVENTION

Silicone Elastomer

Any silicone elastomer is a candidate to serve as a binder or matrix in the mixture of the invention.

Silicone elastomers are well known to the market and can be chosen according to the processing and performance properties. Among commercially available silicone polymers are phenylated silicones such as polymethylphenylsiloxane and polydimethyl/methyl phenyl siloxane; polydiethylsiloxane; fluorinated silicones; epoxy-, amino-, carboxy-, and acrylate-functionalized polydimethylsiloxanes; and the most popular and preferred silicone: polydimethyl siloxane (PDMS).

PDMS can be used in either unreinforced form or reinforced form, depending on the performance properties.

Commercial suppliers of silicone elastomers include Wacker, Burghausen, Germany, and Bluestar of Lyon, France.

Thermally Conductive Particulate Additive

While boron nitride is a well known thermally conductive particulate additive, the amount of loading into silicone elastomer has proven to be inadequate for the amount of thermal conductivity needed by the market for silicone elastomer.

Carbonyl iron powder has been found to serve as an excellent thermally conductive additive for silicone elastomer. Carbonyl iron is a highly pure iron, prepared by chemical decomposition of purified iron pentacarbonyl. It usually has the appearance of grey powder, composed of spherical microparticles. The diameter of the microparticles can range from about 1 to about 10 μm and preferably from about 3 micrometers to about 5 μm.

Table 1 shows acceptable, desirable, and preferable ranges of ingredients useful in the present invention, all expressed in weight percent (wt. %) of the entire mixture. The mixture can comprise, consist essentially of, or consist of these ingredients. Any number between the ends of the ranges is also contemplated as an end of a range, such that all possible combinations are contemplated within the possibilities of Table 1 as candidate mixtures for use in this invention.

TABLE 1

| | Acceptable | Desirable | Preferred |
|---|---|---|---|
| Ingredient (Wt. %) | Range | Range | Range |
| Silicone Elastomer | 10-40 | 10-30 | 10-25 |
| Carbonyl Iron Particles | 60-90 | 70-90 | 75-90 |
| Silicone Crosslinking Agent | 1-2 phr of | 1-2 phr of | 1-2 phr of |
| | Elastomer | Elastomer | Elastomer |

Because of the vast difference in density of the carbonyl iron particles from the silicone elastomer, it is important to recognize the volume percents in acceptable, desirable, and preferred ranges.

Table 2 shows acceptable, desirable, and preferable ranges of ingredients useful in the present invention, all expressed in weight percent (wt. %) of the entire mixture. The mixture can comprise, consist essentially of, or consist of these ingredients. Any number between the ends of the ranges is also contemplated as an end of a range, such that all possible combinations are contemplated within the possibilities of Table 2 as candidate mixtures for use in this invention.

TABLE 2

| | Acceptable | Desirable | Preferred |
|---|---|---|---|
| Ingredient (Vol. %) | Range | Range | Range |
| Silicone Elastomer | 30-65 | 30-60 | 30-55 |
| Carbonyl Iron Particles | 35-70 | 40-70 | 45-70 |
| Silicone Crosslinking Agent | 1-2 phr of | 1-2 phr of | 1-2 phr of |
| | Elastomer | Elastomer | Elastomer |

Both Table 1 and Table 2 are identified as mixtures, because they can serve as either a masterbatch for later dilution into more silicone elastomer or as a fully loaded compound.

Making the Mixture

The preparation of mixtures of the present invention is uncomplicated. The mixture of the present invention can be made using a two-roll mill operating at ambient temperature (approximately 20° C.) with a mixing speed of 30±5 rpm for both back and front mixing speeds to prepare a slab of carbonyl iron powder dispersed in the silicone elastomer. The order of ingredients to be added are elastomer, then iron powder, then the crosslinking agent.

For testing purposes, the silicone elastomer slab can be press-cured into a plaque of 2 mm thickness by force of about 20 Metric tons for about 6 minutes at about 190° C.

For manufacturing purposes, similar batch press-curing operations can be used on a larger scale. A person having an ordinary skill in the art (PHOSITA) of silicone elastomer thermoset formation can apply a variety of methods of final product shaping in the act of curing the silicone elastomer.

Silicone Elastomer Mixtures and Their Uses

The mixtures of the invention are remarkable for their ability to accept very high loadings, to provide excellent through-plane thermal conductivity properties and surprisingly retained elastomeric properties on the Shore A hardness scale.

As measured using the “C-Term Tci” Thermal Conductivity Analyzer from C-Therm Technologies Ltd. of Fredericton, New Brunswick, Canada (ctherm.com), through-plane thermal conductivity of mixtures of the invention, when cured, can range from about 0.4 to about 5 and preferably from about 0.8 to about 2.5 W/mK, for a plaque of 2 mm thickness. The C-Therm TCi thermal conductivity analyzer is based on the modified transient plane source technique. It uses a one-sided interfacial, heat reflectance sensor that applies a momentary, constant heat source to the sample. Both thermal conductivity and effusivity are measured directly and rapidly, providing a detailed overview of the thermal characteristics of the sample material. More information is found at ctherm.com/products/tci_thermal_conductivity/.

As measured using the Shore A Hardness scale, according DIN EN 53504, hardness of mixtures of the invention, when cured, can range from about 1 to about 90 and preferably from about 40 to about 70 degree Shore A.

An added advantage to the use of carbonyl iron powder is magnetism from the iron itself. Thus, mixtures of the present invention can be made into polymer articles of thermoset silicone elastomer which can provide both thermal conductivity and magnetic properties, the latter useful for both electromagnetic interference (EMI) or radio frequency interference (RFI) purposes.

The spherical nature of the carbonyl iron particles provides isotropic performance.

The mixture can also contain one or more conventional plastics additives in an amount that is sufficient to obtain a desired processing or performance property for the silicone elastomer mixture. The amount should not be wasteful of the additive or detrimental to the processing or performance of the mixture, either during milling or curing. Those skilled in the art of thermoplastics compounding, without undue experimentation but with reference to such treatises as Plastics Additives Database (2004) from Plastics Design Library (elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers, fibers, and extenders; flame retardants; smoke suppressants; impact modifiers; initiators; self-lubricating agents; micas; colorants, special effect pigments; plasticizers; processing aids; release agents; silanes coupling agents, titanates and zirconates coupling agents; slip and anti-blocking agents; stabilizers; stearates; ultraviolet light absorbers; viscosity regulators; water scavengers; PE waxes; catalyst deactivators, and combinations of them.

A final silicone elastomer compound can comprise, consist essentially of, or consist of any one or more of the silicone elastomer resins, carbonyl iron particles to impart thermal conductivity and optionally magnetism, in combination with any one or more optional functional additives. Any number between the ends of the ranges is also contemplated as an end of a range, such that all possible combinations are contemplated within the possibilities of Table 3 as candidate compounds for use in this invention. Ratios of the silicone base compound to masterbatch can range from about 1:1 to about 1:10 (about 50% of masterbatch addition to about 90% masterbatch addition) depending on desired final loading and usage rate to achieve that final loading of thermal (and magnetic) particulate additive.

TABLE 3
Silicone Elastomer Compound

| Ingredient (Wt. %) | Acceptable | Desirable | Preferable |
|---|---|---|---|
| Thermoplastic Silicone | 10-94 | 10-93 | 10-92.5 |
| Elastomer(s) and Masterbatch | | | |
| Silicone Elastomer(s) | | | |
| Carbonyl Iron Particles | 6-90 | 7-90 | 7.5-90 |
| Optional Functional Additive(s) | 0-5 | 0-3 | 0-1 |

Processing

The preparation of finally shaped plastic articles is uncomplicated and can be made in batch or continuous operations.

Extrusion, as a continuous operation, or molding techniques, as a batch operation, are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present invention.

The combination of silicone elastomer resin, masterbatch containing carbonyl iron particulate, and optional other functional additives can be made into any extruded, molded, spun, casted, calendered, thermoformed, or 3D-printed article.

Candidate end uses for such finally-shaped silicone elastomer articles are listed in summary fashion below.

Appliances: Refrigerators, freezers, washers, dryers, toasters, blenders, vacuum cleaners, coffee makers, and mixers;

Consumer Goods: Power hand tools, rakes, shovels, lawn mowers, shoes, boots, golf clubs, fishing poles, and watercraft;

Electrical/Electronic Devices: Printers, computers, business equipment, LCD projectors, mobile phones, connectors, chip trays, circuit breakers, and plugs;

Healthcare: Wheelchairs, beds, testing equipment, analyzers, labware, ostomy, IV sets, wound care, drug delivery, inhalers, and packaging;

Industrial Products: Containers, bottles, drums, material handling, valves, and safety equipment;

Consumer Packaging: Food and beverage, cosmetic, detergents and cleaners, personal care, pharmaceutical and wellness containers;

Transportation: Automotive aftermarket parts, bumpers, window seals, instrument panels, consoles,; and

Wire and Cable: Cars and trucks, airplanes, aerospace, construction, military, telecommunication, utility power, alternative energy, and electronics.

Preferably, articles including mixtures of the invention include thermal management (LED-Lighting, Electronics, Automotive); magnetic sealing/damping (Appliances, Furniture, Toys); Damping (Mechatronics); Actuation (Mechatronics); and Electromagnetic Shielding (Wire & Cable, Electronics, and Military)

Embodiments of the invention are further explained by the following Examples.

### EXAMPLES

Tables 4 and 5 identify six Examples and one Comparative Example by their ingredients and test results, and their methods of manufacture, respectively.

TABLE 4
Formulation and Results

| | Comp. | | | | | | | | | | | | | |
|---|---|---|---|---|---|---|---|---|---|---|---|---|---|---|
| Ingredient Name | Example A | | Example 1 | | Example 2 | | Example 3 | | Example 4 | | Example 5 | | Example 6 | |
| CIP SQ Carbonyl Iron Powder | / | | 30 vol.-% | | 39 vol.-% | | 47 vol.-% | | 40 vol.-% | | 49 vol.-% | | 55 vol.-% | |
| (BASF) Approx. 3.9-5.0 | | | or 75.25 | | or 81.93 | | or 86.28 | | or 84.4 | | or 88.64 | | or 90.85 | |
| micrometer diameter; Density: | | | wt.-% | | wt.-% | | wt.-% | | wt.-% | | wt.-% | | wt.-% | |
| 7.874 g/ccm | | | | | | | | | | | | | | |
| Elastosil 401/20 reinforced | / | | 70 | vol.-% | 61 | vol.-% | 53 | vol.-% | / | | / | | / | |
| silicone elastomeric binder | | | | | | | | | | | | | | |
| (Wacker) using Fumed Silica | | | | | | | | | | | | | | |
| reinforcement; Density 1.11 | | | | | | | | | | | | | | |
| g/ccm | | | | | | | | | | | | | | |
| Bluesil 759 unreinforced | 69 | vol.-% | / | | / | | / | | 60 | vol.-% | 51 | vol.-% | 45 | vol.-% |
| silicone elastomeric binder | | | | | | | | | | | | | | |
| (Bluestar, Lyon | | | | | | | | | | | | | | |
| France) Density: 0.97 g/ccm | | | | | | | | | | | | | | |
| Boron Nitride AC 6091, | 31 vol.-% or | | / | | / | | / | | / | | / | | / | |
| Momentive Performance | 50 wt-% | | | | | | | | | | | | | |
| Materials | | | | | | | | | | | | | | |
| Strongsville, OH 44149 USA | | | | | | | | | | | | | | |
| Dicumylperoxide crosslinking | 1.5 | phr | 1.5 | phr | 1.5 | phr | 1.5 | phr | 1.5 | phr | 1.5 | phr | 1.5 | phr |
| agent (Acros, Belgium); Parts | | | | | | | | | | | | | | |
| per hundred of elastomer only | | | | | | | | | | | | | | |
| Thermal Conductivity (C-Term | 0.778 | W/mK | 0.824 | W/mK | 1.289 | W/mK | 1.786 | W/mK | 1.169 | W/mK | 1.710 | W/mK | 2.306 | W/mK |
| Tci) Through Plane of 2 mm | | | | | | | | | | | | | | |

| | | | | | | | |
|---|---|---|---|---|---|---|---|
| Shore A Hardness (DIN 53504) | 37/38° | 44° | 58° | 56° | 41° | 52° | 68° |

TABLE 5
Methods of Preparation

| | |
|---|---|
| Mixing Equipment | Two-roll mill |
| Mixing Temp. | 20° C. (ambient) |
| Mixing Speed | 28 rpm (back), 33 rpm (front) |
| Order of Addition | Silicon Elastomer, then Thermally Conductive |
| of Ingredients | Additive, then Crosslinking Agent |
| Form of Product | Slab of 8 mm × 200 mm × 250 mm |
| After Mixing | |
| Curing | Press-cured at 190° C. at 20 metric tons for six |
| | minutes |
| Plaque Dimensions | Plaque of 2 mm × 120 mm × 120 mm |

Examples 1-3 vs. Examples 4-6 demonstrate that either reinforced or unreinforced silicone elastomer can benefit from the addition of carbonyl iron powder in massive amounts without the loss of Hardness.

Comparative Example A demonstrates that the Examples 1-6 can achieve similar Hardness values even though the density of carbonyl iron particles are much higher than boron nitride.

It has been found that any masterbatch with a higher loading of boron nitride exhibits very poor processing rheology compared to masterbatches filled with carbonyl iron particles at similar volume fractions. It has been found that a masterbatch containing boron nitride cannot be filled much higher 31vol-% (50 wt-%) which means a higher thermal conductivity, e.g., about 1.5 W/mK cannot be established using boron nitride as the only filler.

Moreover, boron nitride particles are not spherical, as is carbonyl iron particles, which means that the boron nitride particles can and do align in a certain pattern under shear processing conditions (a reality in all melt-mixing production processes). Because of alignment, the final product exhibits anisotropic properties, directly affecting the thermal conductivity properties depending on the direction of measurement.

Two other factors can be important. It is known that boron nitride is several times more expensive than carbonyl iron. Also, boron nitride is neither electrically conductive nor magnetic, as is carbonyl iron.

These disadvantages of boron nitride do not predict what has been found, that a mixture of boron nitride at 27.5 vol-% and carbonyl iron powder also at 27.5 vol-% result in acceptable processing rheology and thermal conductivity 2.5 W/mK compared to 2.3 W/mK of Example 6 of carbonyl iron particles alone at 55 vol-%. Thus, the ratio of the mixture of substantially isotropic carbonyl iron particles to substantially anisotropic boron nitride particles can range from about 0.7:1.0 to about 1.3:1.0 and preferably from about 0.9:1 to about 1.1:1.0 (carbonyl iron:boron nitride).

While not being limited to a particular theory, it is believed that the combination of the isotropic carbonyl iron particles and the anisotropic boron nitride particles result in better dispersing and packing of the two types of thermally conductive additive, a concept previously explained in U.S. Pat. No. 6,048,919 (McCullough).

The invention is not limited to the above embodiments. The claims follow.

What is claimed is:

1. A silicone elastomer mixture, comprising:
(a) silicone elastomer and
(b) from about 60 to about 90 weight percent of carbonyl iron particles dispersed in the silicone elastomer,
wherein the silicone elastomer mixture, when crosslinked with a silicone crosslinking agent, has a through-plane thermal conductivity between about 0.8 and about 2.5 W/mK

2. The silicone elastomer mixture, according to claim 1, further comprising additional silicone elastomer which reduces the content of carbonyl iron powder lower than 60 weight percent.

3. The silicone elastomer mixture, according to claim 1, wherein the silicone elastomer is either reinforced or unreinforced.

4. The silicone elastomer mixture, according to claim 3, wherein the reinforcement is fumed silica.

5. The silicone elastomer mixture of claim 3, wherein the silicone elastomer is selected from the group consisting of polydimethyl siloxane; epoxy-, amino-, carboxy-, and acrylate-functionalized polydimethylsiloxanes; phenylated silicones; polydiethylsiloxane; fluorinated silicones; and combinations thereof.

6. The silicone elastomer mixture of claim 1, wherein the mixture also includes a silicone crosslinking agent.

7. The silicone elastomer mixture of claim 1, wherein the carbonyl iron particles are isotropic and present in an amount from about 75 to about 90 weight percent.

8. The silicone elastomer mixture, according to claim 1, wherein the mixture further comprises boron nitride particles.

9. The silicone elastomer mixture of claim 1, wherein the mixture further comprises boron nitride particles.

10. The silicone elastomer mixture of claim 1, wherein the mixture has a Shore A Hardness (DIN EN 53504) ranging from about 1 to about 90° Shore A scale.

11. A silicone polymer compound, comprising:
(a) the mixture of claim 1;
(b) additional amount of silicone elastomer; and
(c) optionally a functional additive selected from the group consisting of anti-oxidants, anti-stats, scavengers, blowing agents, surfactants, biocides, exfoliated nanoclays, ultraviolet stabilizers, water scavengers, colorants, special effect pigments, adhesion promoters, self-lubricating agents, and combinations of them.

12. The compound of claim 11, wherein the compound further comprises biocides; anti-fogging agents; anti-static agents; bonding, blowing, and foaming agents; dispersants; fillers, fibers, and extenders; flame retardants; smoke suppressants; impact modifiers; initiators; micas; plasticizers; processing aids; release agents; silane coupling agents, titanates and zirconates coupling agents; slip and anti-blocking agents; stabilizers; stearates; ultraviolet light absorbers; viscosity regulators; polyethylene waxes; catalyst deactivators, or combinations of them.

13. A shaped article comprising the compound of claim 11, wherein the shape is formed via a process selected from the group consisting of extrusion, molding, spinning, casting, thermoforming, calendering, spinning, or 3D printing.

14. The article of claim 13, wherein the mixture has a Shore A Hardness of from about 40 to about 70° Shore A scale.

15. The article of claim 13, wherein the mixture is magnetic.

16. The silicone elastomer mixture, according to claim 2, wherein the silicone elastomer is either reinforced or unreinforced.

17. The silicone elastomer mixture of claim 2, wherein the mixture further comprises boron nitride particles.

18. A shaped article comprising the compound of claim 12, wherein the shape is formed via a process selected from the group consisting of extrusion, molding, spinning, casting, thermoforming, calendering, spinning, or 3D printing.

19. The article of claim 14, wherein the mixture is magnetic.

20. The silicone elastomer mixture of claim 2, wherein the mixture also includes a silicone crosslinking agent.
